(19) United States
(12) Patent Application Publication
(10) Pub. No.: US 2007/0288252 A1
(43) Pub. Date: Dec. 13, 2007

(54) APPARATUS AND PROCESS FOR PROVIDING INFORMATION ABOUT ALCOHOLIC BEVERAGES

(76) Inventor: David Weinberg, Thornhill (CA)

Correspondence Address: MANELLI DENISON & SELTER, 2000 M STREET NW SUITE 700, WASHINGTON, DC, 20036-3307, US

(21) Appl. No.: 11/691,614

(22) Filed: Mar. 27, 2007

(30) Foreign Application Priority Data
Apr. 5, 2006 (CA) 2,541,912

(51) Int. Cl. G06Q 30/00

(52) U.S. Cl. 705/1

(57) ABSTRACT

Apparatus and method for providing information about an alcoholic beverage, such as wines, spirits, beers and liqueurs requested by a customer in an on-site alcoholic beverage retailer, residence or other establishment in visual format, and optionally a printed format attachment to a label or tag to a beverage bottle, can, or other container. The beverage information may be augmented by personalized information also printed on the label. The apparatus and method may be part of a network linking a plurality of apparatus to a central control and database of beverage information. The apparatus provides requested printed beverage information, optionally in-depth, with personalized information, for subsequent attachment to the bottle, can or the like by the customer for transfer to another person, as a gift, which provides fully described information.

### FIELD OF THE INVENTION

This invention relates to apparatus and process for providing visual information about specific alcoholic beverages, such as wines, spirits, beers and the like, to a customer upon demand in a retail, commercial or industrial establishment, or by a person in a residence or small office as a stand alone on-site, system or part of a network linking a plurality of such apparatus through a central control unit.

### BACKGROUND OF THE INVENTION

Individual or a plurality of alcoholic beverages bought by the bottle, can, or other container in a beverage or beer shop or other establishment, by a customer has very limited information on the printed label. The customer selects and purchases the beverage based on generally limited knowledge, past experience, or recommendation from another person. In the situation where the customer is buying the beverage on behalf of another person as, for example, a gift, lack of knowledge about the beverage often causes anxiety, apprehension and possible subsequent embarrassment should the beverage not be enjoyed by the recipient.

While the proprietor, staff, wholesaler and supplier may be most knowledgeable and helpful in providing desired information to the individual customer-purchaser, this information is invariably given orally at the retail store or by telephone from customer service personnel. However, this information would generally not be communicated to the resultant gift-receiving recipient in a convenient manner, if at all.

There is, therefore, a need to provide a purchaser and, most preferably, an eventual recipient of desired information about the specific beverage(s) purchased.

Further, there is a need for providing a person desirous of such beverage information in that person's residence or office other than as a customer-purchaser.

### SUMMARY OF THE INVENTION

It is an object of the present invention to provide a process of providing information about a specific beverage(s) upon demand by a person in a timely, convenient, pleasant, visual manner, within wine or beer shop or other similar establishment, such as a grocery store or “Big Box” retailer, for example, or at that person's residence or other establishment.

It is a further object to provide said information in a printed format.

It is a yet further object to provide apparatus for providing said information in a visual, particularly printed format.

It is a yet further object to provide a network of said apparatus.

Accordingly, in one aspect the invention provides a method for providing a person with desired beverage information in a visual format upon demand by said person, said method comprising
(a) feeding identifying information to a beverage information dispensing apparatus;
(b) reading said identifying information;
(c) accessing stored data containing said desired beverage information; and
(d) visually displaying said desired beverage information to said person.

The invention preferably provides a method as hereinabove defined further comprising
(e) feeding supporting information to said apparatus; and
(f) printing out, in whole or in part, said desired beverage information.

More preferably, the invention provides a method as hereinabove defined further comprising
(g) feeding personalized information to said apparatus; and
(h) printing out said personalized information.

The invention preferably provides a method as hereinabove defined further comprising
(i) billing an amount for the printing of said desired beverage information to said person.

The invention further provides a method as hereinabove defined further comprising printing and outputting a receipt for said billed amount.

Preferably the identifying information is in machine-readable format.

Accordingly, in a further aspect the invention provides a method for providing a person with desired alcoholic beverage information in a visual format upon demand by said person, said method comprising
(i) providing CPU means;
(ii) feeding identifying information to said CPU means;
(iii) accessing stored data containing said desired beverage information under the control of said CPU means; and
(iv) visually displaying said desired beverage information to said person by means of a display screen or a printed article.

The invention in a preferred aspect provides a method as hereinabove defined further comprising billing means for billing an amount for the printing and outputting of said beverage information to said person.

Preferably, the alcoholic beverage is a wine, spirit or beer, fortified or otherwise. The spirit may be selected from, but is not limited to, a whisky, rum, vodka, gin, liqueur, brandy, port and sherry. The beer may be selected from, but is not limited to an ale, lager and cider.

Most preferably, the alcoholic beverage is a wine.

In a further aspect, the invention provides apparatus for delivering desired beverage information upon request by a person; said apparatus comprising
(a) receiving means for receiving instructions from said person;
(b) accessibility means to data storage means containing said desired beverage information cooperable with said receiving means;
(c) display means containing said desired beverage information cooperable with said data storage means; and
(d) CPU means in communication with said receiving means, said accessibility means, said data storage means and said display means, to effect display of said beverage information to said person upon said instructions from said person.

The receiving means of use in the practise of the invention includes all means by which the inputted information is assimilated by the apparatus, which includes, for example, means for reading a machine readable code, a bar code, say, suitably located on the beverage bottle, can, case or other container specific to that beverage. In alternative embodiments, the receiving means may comprise an entering touch key arrangement as, for example, a pad or touch screen computer system cooperable with the CPU means.

The data storage means may be located within the apparatus, as hereinabove defined, or, alternatively, located remotely “off-site” and accessible through the accessibility means to the apparatus via telephone or dedicated land lines, electronic, wireless, or other means, individually or as part of a network or like arrangement to a central database. The term “within said apparatus” indicates “on”, “affixed to”, “adjacent in close proximity to the apparatus and the like to the apparatus, with the retail or like store, which is distinct from “located remotely” off-site or outside of the retail or like store.

The visual display means may, optionally, comprise a visual screen by which the purchaser can read and, optionally, select which or all parts of the text, which includes verbal and pictorial representations, the purchaser may wish to have, subsequently, printed out.

A most preferred aspect of the apparatus according to the invention is the presence and utilization of a printing means by which the desired, selected information is provided in printed format on a label, tag or the like which may be, optionally, adhered or affixed to the beverage bottle or other container.

In a further feature, the apparatus may, optionally, provide means by which the dispensed label or tag includes personalized information, such as for example, purchaser and recipient names and greetings or other salutations.

The CPU within the apparatus provides the necessary link between the aforesaid defined integers for the purposes defined.

Preferably, the invention provides feeding personalized information to the CPU and displaying the personalized information on the printed article.

By the term “identifying information” is meant information, such as, for example, but not limited thereto, identifying the beverage of which the desired beverage information from the database is required.

By the term “supporting information” is meant details by which the person can be billed, charged and the like by means of, for example, credit or debit card, for paying for the use of the invention apparatus and process.

By the term “personalized information” is meant the personal information as hereinbefore defined.

In a further aspect, the invention provides a beverage information delivery network comprising

a plurality of on-site apparatus as hereinabove defined; and

a central control and data storage means cooperable with each of said apparatus, to provide said beverage information to said apparatus upon request.

The network may be cooperable with the apparatus by means of an electronic or telephonic land line means or wireless transition means.

The desired beverage information sought by or offered to the purchaser and stored in the data storage means includes, for example, in respect of a wine, the usual characteristics of the beverage, e.g. year, geographic region, type of grape, dryness, and the like, along with, for example:
(a) when to drink the beverage(s) later—number of months and years;
(b) key factors in the storage of the beverage;
(c) temperature at which the beverage should be drank and with the type of food, beverage glass, decanting and accompanying beverages; and
(d) beverage region information and gossip, including, for example, tasting notes and critic wine rating information.

The invention is also applicable where the intended purchaser or a person is desirous of obtaining information by the method of the invention directly from a data base stored “off-site” at the vineyard, winery, brewery or spirit manufacturing establishment. The apparatus according to the invention in one embodiment has “log-in” access facilities to enable such access by the person.

A preferred embodiment of the apparatus according to the invention, exemplified in respect of a wine enquiry, is in the form of a kiosk that has
1. Backlit header for signage/instructions/features and advertising potential.
2. Touch screen computer system.
3. Integrated bar code reader—include direction label to position bottle.
4. Database of, or access to, the retailer's inventory with the appropriate information.
5. Credit card swiper or reader—include direction label to insert card.
6. Label printer and output tray to support printed labels.
7. Integrated locking supply cabinet for printing supplies—labels, ink and the like.
8. Integrated shelf to hold beverage bottles.
9. Maximum customer exposure with minimal interruption of sight-lines.
10. Wireless internet access to permit monitoring of use, supplies and to change screen messages and advertising.

The apparatus according to the invention may be in the form of a stand alone unit, such as a kiosk, suitably placed on the floor or countertop in a retail location, such as a boutique beverage shop, beer store, convenience store, and the like.

Such a kiosk or like unit could constitute a customer service provider, silent salesperson and a means of freeing up in-store sales associates to perform other tasks, such as, stacking of beverage bottles, cans and the like on the shelves. Further, it could be used as a training tool for use by the trainee staff. The unit may also be of value to the store owner in being associated with accessory articles, such as, for example, glasses and decanters, beer mugs and glasses to enhance sales of these products.

In general practise of the invention, a customer selects a bottle or can of beverage from a shelf or store display, takes it to the apparatus (kiosk) and, for example, scans the bar-code label on the bottle or can under the reader of the receiver information means of the apparatus.

The desired information obtained from the data storage means via the CPU activated by the reader of the bar code, is displayed on the visual screen, optionally a touch screen. This displayed easy-to-understand information may be provided free of charge.

However, desired information subsequently selected by the customer to be printed may now, optionally, be chargeable by the store owner or by the owner of the kiosk, or some other authorized party, by means of a debit card, credit card or like means. The selected information pertaining to the selected beverage may be accompanied by personal information inputted by the customer from messages such as, Happy Birthday, Happy Anniversary, Happy Holidays, religious salutations, names and the like available from the system. The resultant information may be pre-viewed as to format prior to the giving of instructions to print on a selected label, card, tag or the like, which is then adhered or affixed to the bottle, can or other container, e.g. barrel, keg or drum.

By the term “on-site” is meant a location selected from retail, commercial, industrial or like sites where the apparatus is generally not owned by the person desirous of the beverage information.

By the term “personal” is meant residences, homes, apartments, small offices, but not limited to other locations where the apparatus is owned or leased by the person desirous of the beverage information.

Accordingly, in a further aspect, the invention provides methods, apparatus and network, thereof, as hereinabove defined, wherein said apparatus is a personal apparatus.

The individual home use with personal apparatus allows access to a beverage information database and provide the desired beverage information and to enable this information to be personalized, printed and attached to the bottle, either with a label or a tag, as hereinabove described.

In operation of one embodiment of this aspect, a proprietary home user accesses the database, via an internet connection to the proprietary website. A barcode scanner attached to a home user's computer, preferably, can be used to “read” the barcode on individual bottles, cans and the like.

The aforesaid process can generate revenues in at least one of two ways, for example,
(a) via a monthly membership fee, or,
(b) via a transaction credit card payment.

The home user actions will, typically, entail:
(i) use of a personal computer to go to the proprietary web site;
(ii) enter User ID and Password to log into system;
(iii) use bar code scanner attached to this PC to scan the, typical, label on the beverage bottle, can or the like for an individual bottle, can or the like, or, typically, personal wine or spirit bottle inventory, wherein
(iv) the PC monitor will show information pertinent to the item. There may be, optionally, advertising links contained here.

By use of the PC keyboard, the home user can request to—
a. print the featured information;
b. select only those fields desired to be printed;
c. use a comment area to personalize the information group with messages, notes, greetings, salutations and the like, as hereinbefore described;
d. font automatically adjusted to fill and balance space; and
e. preview features and then choose “print”.

The home user could purchase a supply of tags, labels, cards and the like from a proprietary website or potential retain partners to print this on labels, cards or tags and affected to beverage bottles, carton or case as hereinabove described.

### BRIEF DESCRIPTION OF THE DRAWINGS

In order that the invention may be better understood, preferred embodiments will now be described by way of example, only, with reference to the accompanying drawings wherein

FIG. 1 is a diagrammatic block diagram of an information dispensing apparatus according to the invention;

FIG. 2 is a diagrammatic perspective view of a stand-alone, on-site apparatus or kiosk according to the invention;

FIG. 3 is a diagrammatic block diagram of a plurality of apparatus according to the invention linked to a central database as part of a network;

FIG. 4 illustrates a flow chart of the operation of an apparatus according to the invention;

FIG. 5 is a diagrammatic sketch of a personal apparatus according to the invention; and wherein the same numerals denote like parts.

### DETAILED DESCRIPTION OF PREFERRED EMBODIMENTS

The following description is made in reference to wherein the beverage is a fine wine. It is equally applicable to a mature spirit, such as a malt whisky or expensive liqueur.

With reference to FIG. I this shows generally as 10, apparatus having a central processing unit 12 in communication with receiving means 14, data storage means 16, visual screen 18 and printing means 20.

Receiving means 12 in this embodiment has a machine-readable barcode reader 22, which reads barcode 24 on beverage bottle 26, presented by a person (not shown) requesting the desired beverage information.

The request is received by CPU 12 who instructs data storage 16 to supply the desired information 30 to display terminal 18 to be read by the person. If the person wishes to receive all or a portion of information 30 in a printed, outputted format on a label, tag or card 32, supportive information in the form of a debit card, credit card or via a key-padded digital input 34, is provided to receiver 14, which transfers this information to CPU 12 which instructs printer 20 to output printed card 32.

Personal information e.g. name of recipient and/or person—customer and/or salutations, and the like can be inputted to receiver 14 for transfer to printer 20 via CPU 12.

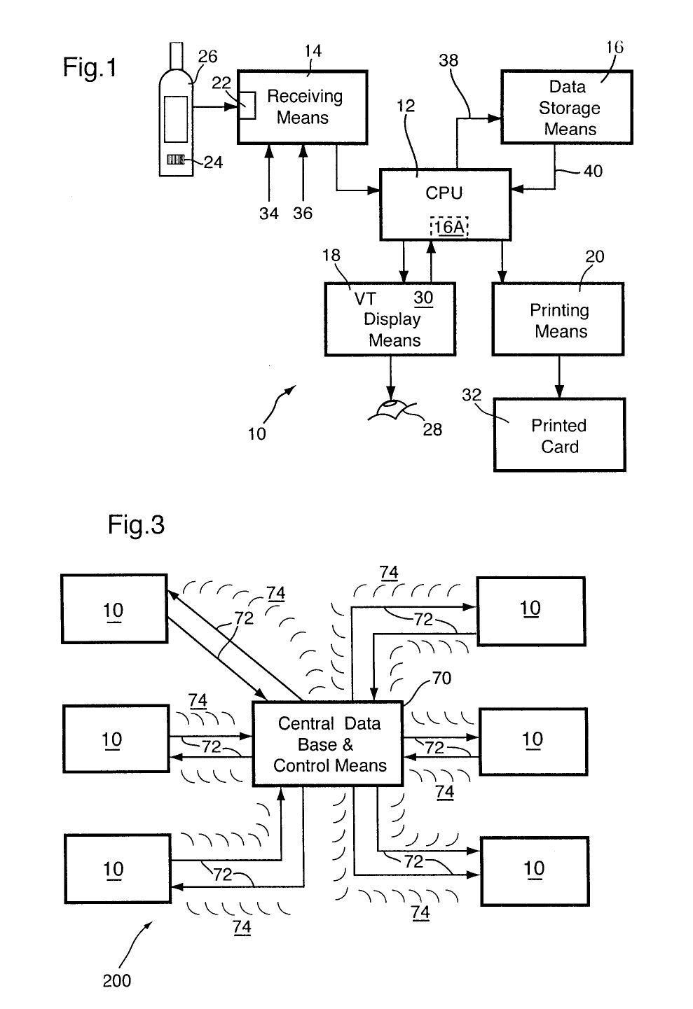

In an alternative embodiment, FIG. 1 shows an independent, internal data storage 16A in lieu of external data storage 16.

In both embodiments, the apparatus has independent accessibility means, shown as 38, 40 or within 16A (not shown).

FIG. 2 shows an on-site, stand alone apparatus, generally as 100, having a housing 50, visual and computer-touch screen 52, bar code reader 54, credit card reader 56, label printer 58 and peripheral features, namely, beverage bottle apertures 60, shelf 62, open armed header 64 or lower integrated 66 for signage and advertising. The inner integers, namely, CPU 12, data storage 16A and connecting conduits are not shown.

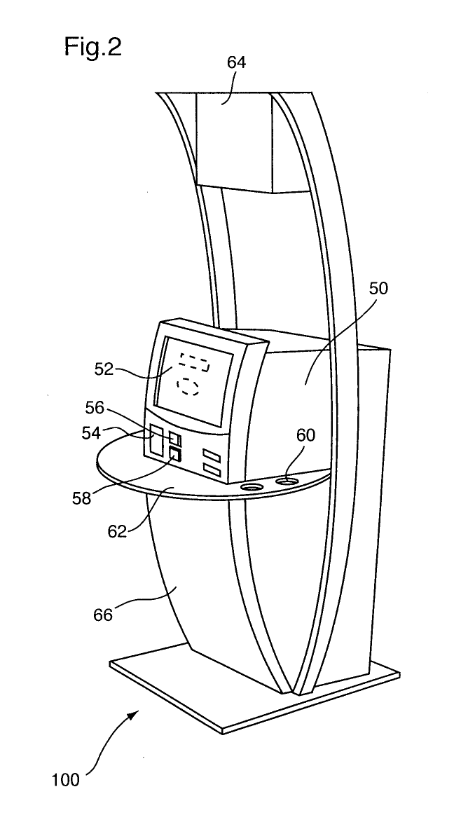

FIG. 3 shows, generally as 200, a network having a plurality of apparatus 10, linked to central database and control unit 70, by hard-wired conduits 72, or wireless transmission 74, or a combination of both.

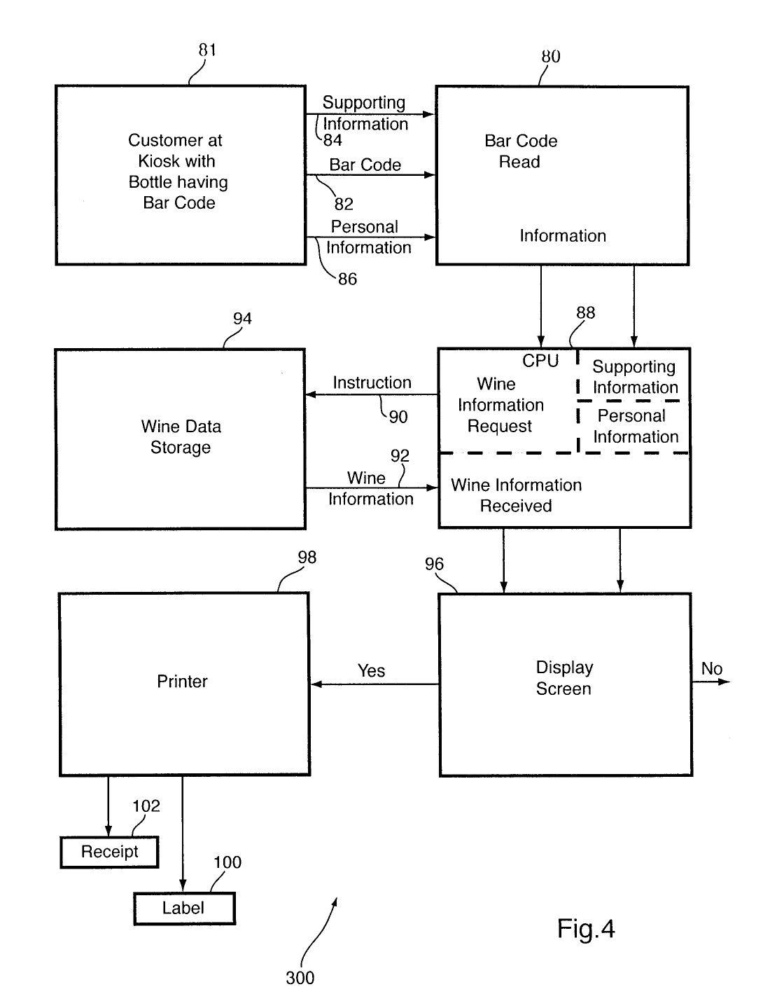

Flow chart shown generally as 300, in FIG. 4 shows information receiver 80 provided with means (not shown) for accepting from a customer 81, a request for beverage information 82, supportive credit card information 84 and/or personalized information 86. The information is accepted and treated under the control of CPU 88. Wine information 90 is requested from, and provided by 92, wine data storage 94. The wine information is displayed on display screen 96, and, optionally, if desired by customer, printed and outputted by printer 98 on label 100, subject to receipt of supportive information 84. The personalized information may be, optionally, also printed and outputted on label 100. Receipt 102 may be provided to identify the amount billed for the printing service.

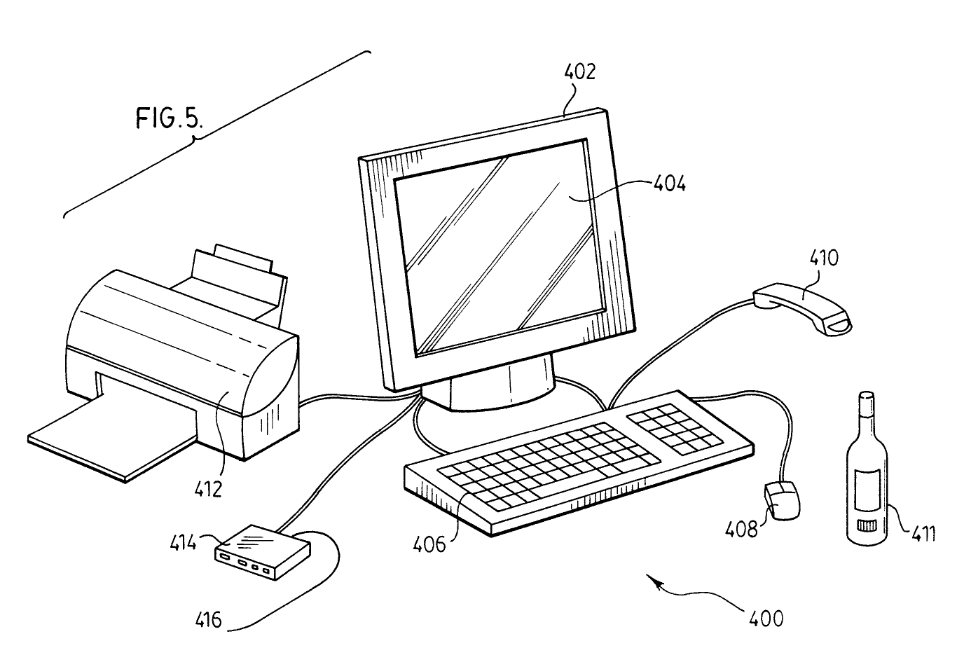

With reference to FIG. 5, this shows generally as 400, a personal apparatus having a CPU 402 with monitor screen 404, keyboard 406, mouse 408, barcode scanner 410, for reading barcode on beverage bottle 411, printer 412, with internet access through cable 416.

In operation, as hereinbefore described, the user's actions include
(i) use of a personal computer to go to the proprietary web site;
(ii) enter User ID and Password to log into system;
(iii) use bar code scanner attached to this PC to scan the, typical, label on the beverage bottle for an individual bottle, or, typically, personal beverage bottle inventory, wherein
(iv) the PC monitor will show information pertinent to the item. There may be, optionally, advertising links contained here.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A method for providing a person with desired information about an alcoholic beverage in a visual format upon demand by said person, said method comprising
(a) feeding identifying information to an alcoholic beverage information dispensing apparatus;
(b) reading said identifying information;
(c) accessing stored data containing said desired beverage information; and
(d) visually displaying said desired beverage information to said person.

2. A method as claimed in claim 1 further comprising
(e) feeding supporting information to said apparatus
(f) printing out, in whole or in part, said desired beverage information.

3. A method as claimed in claim 1 further comprising
(g) feeding personalized information to said apparatus; and
(h) printing out said personalized information.

4. A method as claimed in claim 2 further comprising
(i) billing an amount for the printing of said desired beverage information to said person.

5. A method as claimed in claim 4 further comprising
(j) printing; and
(k) outputting a receipt for said billed amount.

6. A method as claimed in claim 1 wherein said identifying information is in machine-readable format.

7. A method for providing a person with desired beverage information in a visual format upon demand by said person, said method comprising
(i) providing CPU means;
(ii) feeding identifying information to said CPU means;
(iii) accessing stored data containing said desired beverage information under the control of said CPU means; and
(iv) visually displaying said desired beverage information to said person by means of a display screen or on a printed article.

8. A method as claimed in claim 7 further comprising feeding supporting information to said CPU means.

9. A method as claimed in claim 8 further comprising (v) feeding personalized information to said CPU and displaying said personalized information on said printed article.

10. A method as claimed in claim 8 further comprising (vi) printing and outputting a receipt for said billed amount.

11. Apparatus for delivering desired beverage information upon request by a person; said apparatus comprising
(a) receiving means for receiving instructions from said person;
(b) accessibility means to data storage means containing said desired beverage information cooperable with said receiving means;
(c) display means containing said desired beverage information cooperable with said data storage means; and
(d) CPU means in communication with said receiving means, said accessibility means, said data storage means and said display means, to effect display of said beverage information to said person upon said instructions from said person.

12. Apparatus as claimed in claim 11 wherein said data storage means is located within said apparatus.

13. Apparatus as claimed in claim 11 wherein said data storage means is remotely located from said apparatus, and said accessibility means is operably connectable to said data storage means.

14. Apparatus as claimed in claim 11 wherein said display means comprises a display screen.

15. Apparatus as claimed in claim 11 wherein said display means comprises printing means for providing a printed article displaying said desired beverage information.

16. Apparatus as claimed in claim 11 wherein said receiving means comprises means selected from the group consisting of means for reading a machine readable code, a bar code, means for receiving keyed-in information, touch screen computer means and means for reading credit card data.

17. Apparatus as claimed in claim 11 wherein said receiving means further comprises means for receiving and forwarding personalized data to said printing means to provide said personalized data on said printed data.

18. Apparatus as claimed in claim 15 further comprising billing means for billing an amount for the printing and outputting of said beverage information; and means for printing and outputting a receipt for said bill amount.

19. Apparatus as claimed in claim 11 wherein said apparatus is the group consisting of “on-site” apparatus and personal apparatus.

20. A beverage information and delivery network comprising a plurality of on-site apparatus as claimed in claim 11; and
a central control and data storage means cooperable with each of said apparatus to provide said beverage information to said apparatus upon request.

21. A method as claimed in claim 1 wherein said alcoholic beverage is selected from wine, beer, spirit and liqueur.

22. Apparatus as claimed in claim 11 wherein said alcoholic beverage is selected from wine, beer, spirit and liqueur.

23. An information and delivery network as claimed in claim 20 wherein said alcoholic beverage is selected from wine, beer, spirit and liqueur.
